(19) United States
(12) Patent Application Publication
(10) Pub. No.: US 2011/0226873 A1
(43) Pub. Date: Sep. 22, 2011

(54) SELF-CLEANSING AUTOMATED SHOWER ATTACHMENT

(75) Inventor: Edgar Lehrer Bronstein, Caracas (VE)

(73) Assignee: ELIMO INTERNATIONAL, LLC, Miami, FL (US)

(21) Appl. No.: 12/827,721

(22) Filed: Jun. 30, 2010

Related U.S. Application Data
(63) Continuation-in-part of application No. 12/725,138, filed on Mar. 16, 2010.

(51) Int. Cl. B05B 15/00

(52) U.S. Cl. 239/289

(57) ABSTRACT

The invention is directed to a shower attachment which first includes a vertical assembly having a top end, a corresponding bottom end and a stabilizing bar encased by an outer shell. The outer shell includes a slit to gain access to the stabilizing bar. Positioned at the top of the vertical assembly is a shower head that receives pressurized water from a water intake connected to the plumbing of the existing shower enclosure. Attached to the vertical assembly is a multi pivot arm having a first arm and corresponding second arm. This second arm includes a first track and corresponding second track in parallel relation to one another. Positioned at the distal end of the second arm is a dispenser having a quantity of cleanser.

### CROSS-REFERENCE TO RELATED APPLICATIONS

This application is a continuation-in-part of U.S. application Ser. No. 12/725,138, filed Mar. 16, 2010, the disclosure of which is hereby incorporated by reference herein in its entirety all commonly owned.

### FIELD OF THE INVENTION

This invention is directed to a shower attachment attachable to an existing shower enclosure for purposes of rotating and pivoting about a user to deliver, through automation, soap or similar cleansing material.

### BACKGROUND OF THE INVENTION

Traditional shower systems used over the past 50 years have primarily included a showerhead and a series of valves for regulating the temperature of the shower (as well as control the follow of water to the showerhead). Most advances in the field of showerhead design have included various showerheads that variate flow of pressurized water to effectuate a massage. Other advances have included placement of multiple showerheads in series to create an envelope or cascade of water around a user. These additional showerheads are placed along the shower enclosure wall or on the ceiling of the shower. All of these advances have focused on the same fundamental shower system of a showerhead and regulating valves.

Review of patents dealing with shower systems highlights these limited advances. U.S. Pat. No. 4,563,780 entitled “Automated Bathroom” is directed to a system for regulating bathroom activities such as showering. However, the invention primarily relates to introducing bath additives and cleaning solutions to maintain the cleanliness of the bathroom.

Showering remains a fundamental regiment to ensure cleanliness as well as reduce the spread of disease. This is especially true and important in hospitals, nursing homes and assisted living facilities. It is often the case that individuals being treated at these facilities have infirmities that prevent them from showering without assistance. However, assistance when showering is not only uncomfortable and embarrassing for the infirmed individual—but also requires a significant level of time and patience on the part of the professional assisting.

Very little has been done to create shower systems to assist infirmed individuals who cannot stand upright to take a shower. Moreover, there have been very little inroads to design a system to deliver a cleanser such as soap, shower gel or similar surfactant to help clean infirmed individuals.

Apart from shower systems for assisting infirmed individuals, there have also been very little advances in the field of automated shower systems for domestic use for effectuating a spa like experience. Current shower systems can optionally include a hand wand that is attached to the regulating valves. A flexible tube attaches the hand wand to the regulating valves such that the user can have greater freedom to provide direct water pressure to various parts of the user's torso. Optionally, these hand wands can include settings to allow changes in pressure. By engaging the hand wand, water is diverted from the showerhead (typically located above the wand) and thus allows for a more spa like feel.

Accordingly, there is a need in the art of shower system design for a robust attachment to an existing shower system to allow an infirmed individual to shower without need of assistance. Moreover, such attachment should provide a complete shower to those infirmed individuals with limited motor skills. Optionally, such attachment should allow delivery through automation of a cleanser (such as soap or shower gel) to the infirmed individual. In addition, there is a need in the art of domestic shower systems for an attachment that provides a spa like massage. Preferably, such device can be interchangeably used for both domestic and assisted living facilities in order to be mass-produced in a cost effective manner.

### SUMMARY OF THE INVENTION

The current invention solves many of the limitations and shortcomings found in the art of shower systems. The invention is directed to a shower attachment which first includes a vertical assembly having a top end, a corresponding bottom end and a stabilizing bar encased by an outer shell. The outer shell includes a slit to gain access to the stabilizing bar. Positioned at the top of the vertical assembly is a shower head that receives pressurized water from a water intake connected to the plumbing of the existing shower enclosure. Attached to the vertical assembly is a multi pivot arm having a first arm and corresponding second arm. This second arm includes a first track and corresponding second track in parallel relation to one another. Positioned at the distal end of the second arm is a dispenser having a quantity of cleanser.

Positioned within the outer shell of the vertical assembly is a power train which includes an upper threaded gear that connects to the stabilizing bar via a top positioning brace, as well as a lower threaded gear which connects to the stabilizing bar through a bottom positioning brace. Attached to both the upper and lower threaded gears is a rotating chair which is in communication with the power train. Such power train can include a paddle drive capable of powering the rotating chain and a directional feed which positions pressurized water either above or below the paddle drive. Optionally, the first arm of the multi pivot arm can be attached to the stabilizing bar via a first hinge (powered by a first motor), while the first end of the second arm attaches to the first arm through a second hinge (powered by a second motor). Moreover specifically, the first hinge attaches to the stabilizing bar via an annular sleeve having a perpendicular engaging bar.

The vertical assembly can further include a shower wand that can detach from the vertical assembly via a holder. The shower wand has a plurality of jet sprays and a selector which allows various massage settings to be used.

The shower attachment can further include a controller in communication with the power train positioned within the vertical assembly, the multi pivot arm, and the dispenser. The controller may include a processor, a memory device in communication with the processor, a power supply to provide electricity to both the memory device and power supply and a display.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of the shower attachment that includes the vertical assembly;

FIG. 2 is a front view of the shower attachment that includes the dispenser;

FIG. 3 is a perspective view of the pivot arm containing the dispenser;

FIG. 4 is a perspective view showing the components of the dispenser;

FIG. 5 is a side view of the dispenser showing its various components;

FIG. 6 is a front review of the dispenser showing its various components;

FIG. 7 is a left side view of the vertical assembly;

FIG. 8 illustrates a hydraulic power train for purposes of powering a chain about a series of threaded gears to position the multi pivot arm about the vertical assembly;

FIG. 9 illustrates an electro-mechanical power train used to position a multi pivot arm about the vertical assembly;

FIG. 10 illustrates the stabilizing bar positioned within the shell of the vertical assembly;

FIG. 11 is a top view of the shower attachment showing the optional shower wand;

FIG. 12 is a diagraph showing the components of the controller; and

FIG. 13 is a schematic illustrating how the controller communicates with the vertical assembly and pivot arm.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overall Components of the Shower Attachment

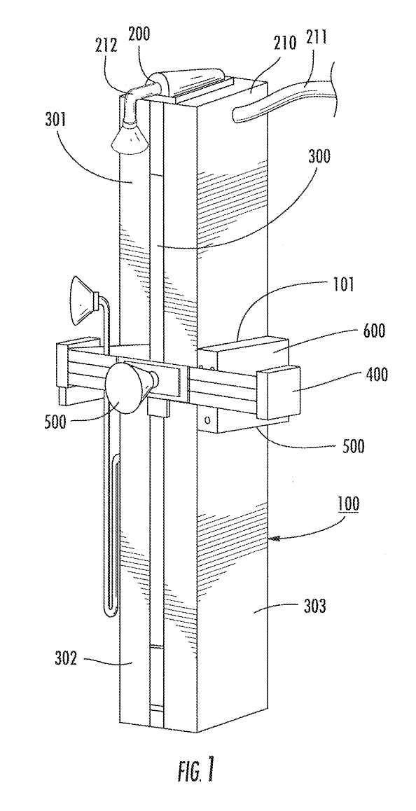

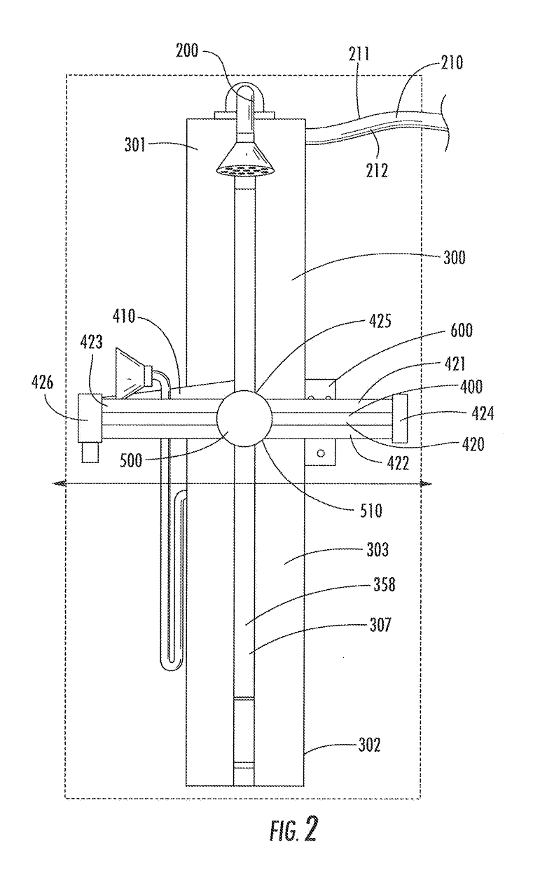

Both FIG. 1 and FIG. 2 illustrate, by way of example, preferred components 101 of the enhanced shower attachment 100. First turning to FIG. 1, components 101 of the shower attachment 100 may include (but are not necessarily limited to): a pivoting top showerhead 200, a vertical assembly 300, a multi pivot arm 400 attached to the vertical assembly 300, a dispenser 500 and a controller 600. One of ordinary skill in the art, upon review of the various figures and disclosure contained here, shall recognize additional components 101 which can be included with the shower attachment 100.

FIG. 2 further illustrates how the various components 101 of the shower assembly 100. As shown, a water intake 210 receives water from existing shower plumbing, most likely piping which would normally feed a traditional shower head. Such water intake 210 includes a conduit 211 which transfers pressurized water 212 to the vertical assembly 300.

As further shown in both FIG. 1 and FIG. 2, the vertical assembly 300 is essentially rectangular in cross section and includes a top end 301, a corresponding bottom end 302 and an exterior shell 303. Positioned on the top end 301 of the exterior shell 300 is a pivoting top showerhead 200. The conduit 211 provides pressurized water 212 to the pivoting top showerhead 200. In turn, the pivoting top showerhead 200 offers a vertical cascade of pressurized water 212 to a user. Moreover, the top shower head 200 can rotate about the user to provide a greater range of spray of the pressurized water 212 (as described in greater detail below).

Attached to the vertical assembly 300 is a multi pivot arm 400. As shown in FIG. 2, the multi pivot arm 400 includes a first arm 410 and corresponding second arm 420. In turn, the second arm 420 includes a first track 421 and corresponding second track 422 (in parallel relation to one another). The second arm 420 includes a first end 423 and corresponding second end 424. The multi pivot arm 400 connects to the vertical assembly 300 through a first hinge 425. The first arm 410 then connects to the first end 423 of the second arm 420 via a second hinge 426.

Positioned proximate the second end 424 of the second arm 420 is the dispenser 500. The dispenser 500 is capable gliding about the second arm 420 between the first track 421 and second track 422. Put another way, the dispenser 500 can travel from the second end 424 to the first end 423 of the second arm 420 to administer a cleanser 510. Such cleanser 510 can be soap, shower gel, antibacterial/antimicrobial solution or any similar surfactant known to those of ordinary skill in the art. Moreover, such cleanser 510 can also be a topical solution such as a moisturizer material to prevent dry skin or skin irritation.

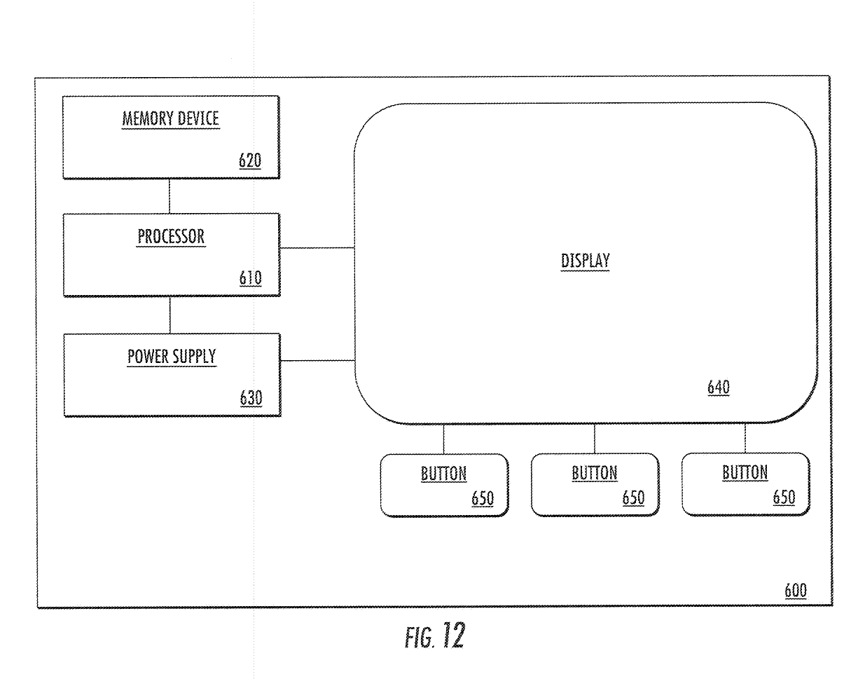

Attached to the vertical assembly 300 is a controller 600 which functions to operate and control various routines for the enhanced shower attachment 100. Preferably, the controller 600 includes, but is not necessarily limited to, a processor 610, a memory device 620, a power supply 630 (which can be a battery), and a display 640 (all illustrated in FIG. 12). The controller 600 communicates with the top pivoting shower head 200, vertical assembly 300, multi pivot arm 400 and dispenser 500 to automate various shower sequences for various purposes. Such sequence can be user specific or task specific (assisting an infirmed individual, providing a moisturizing treatment, or spa like massage).

### The Dispenser

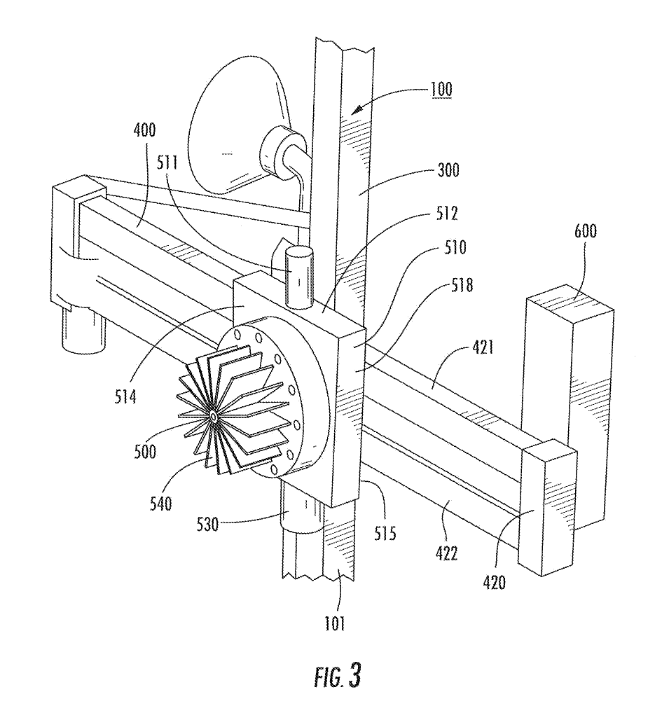

FIG. 3 through FIG. 6 illustrate the various components 101 of the dispenser 500. First, FIG. 3 shows both placement and location of the dispenser 500 on the shower attachment 100. Although such dispenser 500 can be placed and positioned directly upon the vertical assembly 300, it is preferable that the dispenser 500 be affixed to some form of rotating means. As shown in FIGS. 1-3, the invention contemplates use of a multi pivot arm 400 having a first arm 410 and corresponding second arm 420. Such pivot arm 400 should allow not only horizontal movement in relation to the vertical assembly 300 but also the ability to position the dispenser 500 about the torso of the user.

As further shown in FIG. 3, the dispenser 500 is preferably attached to the distal end of the multi pivot arm 400. Although the dispenser 500 can be positioned along any portion of the multi-pivot arm 400, it is preferably positioned between the first track 421 and corresponding second track 422 of the second arm 420. This allows the dispenser 500 to glide between both tracks 421 and 422 for proper positioning.

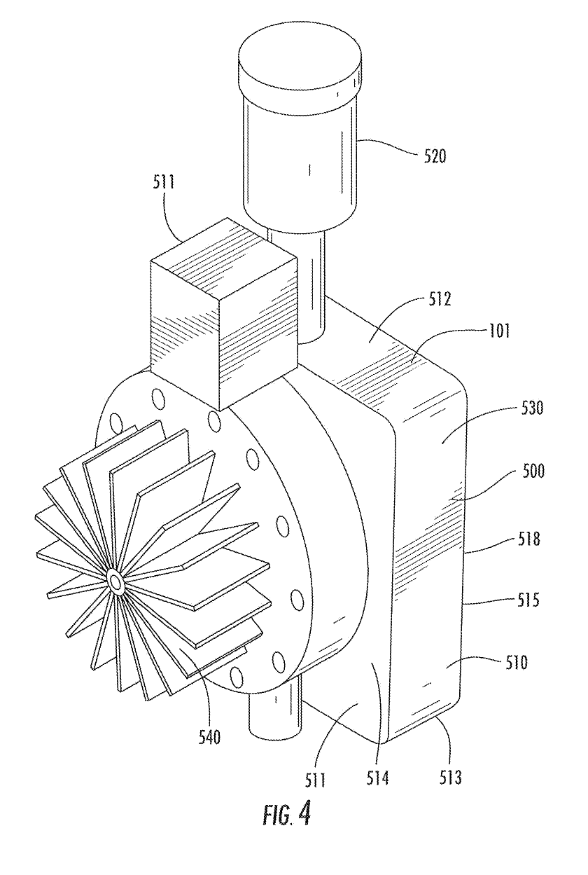

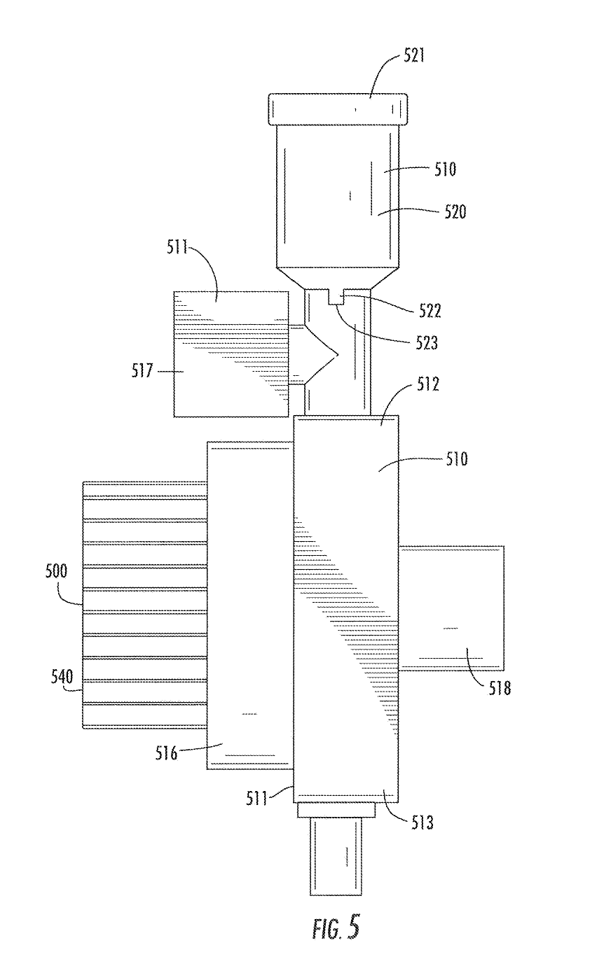

FIG. 4 illustrates, by way of example, the primary components 101 of the dispenser 500. As shown, the dispenser 500 includes four primary members: a central housing 510 (containing a plurality of sensors 511), a fluid container 520, a rotation motor 530, and a spindle brush 540. The central housing 510 is essentially square in shape and orientation, and includes a top side 512, a bottom side 513, a front side 514 and a corresponding back side 515. The back side 515 includes a fastener 518 (shown in FIG. 5) sufficient to attach to the second arm 420 of the multi track arm 400.

As further shown in FIG. 5, the central housing 510 includes a plurality of sensors 511, as well as other components 101 to assist the function of the dispenser 500. One form of sensor 511 contemplated by the invention is a pressure sensor 516. The pressure sensor 516 communicates with the spindle brush 540 to ascertain if the dispenser 500 is in direct contact with a user—to gauge whether to disburse a cleanser 510.

A second sensor 511 contemplated by the invention is a motion sensor 517. The motion sensor 517 functions to ascertain if the user is sufficiently close to the spindle brush 540. Such motion sensor 517 not only measures if the user is proximate to the dispenser 500, but also if there is any motion by the user suggesting comfortableness, a health risk, or any related medical issue, while a shower is being administered. As shown, the motion sensor 517 can be positioned at the top side 512 of the central housing 510.

Also illustrated in FIG. 5, the dispenser 500 includes a fluid container 520 positioned at the top side 512 of the central housing 510, above the motion sensor 517. Preferably tubular in shape and translucent in construction, the fluid container 520 is a sufficient size and dimension to house and maintain an appropriate quantity of cleanser 510. Optionally, the fluid container 520 can contain a screw lid 521 which can be twisted and removed to allow access for refilling of cleanser 510.

A screw bottom 522 can be positioned at the base of the fluid container 520 which includes a check valve 523. By twisting the screw bottom 522, the entire fluid container 520 can be removed such that any remaining cleanser 510 will not escape due to use of the check valve 523. This allows another replacement fluid container 520 to be positioned and attached to the dispenser 520. Through this structure, one fluid container 520 could be used to administer soap or shower gel, while a second fluid container 520 could be attached to offer either an antibacterial treatment or a moisturizer to prevent dry skin.

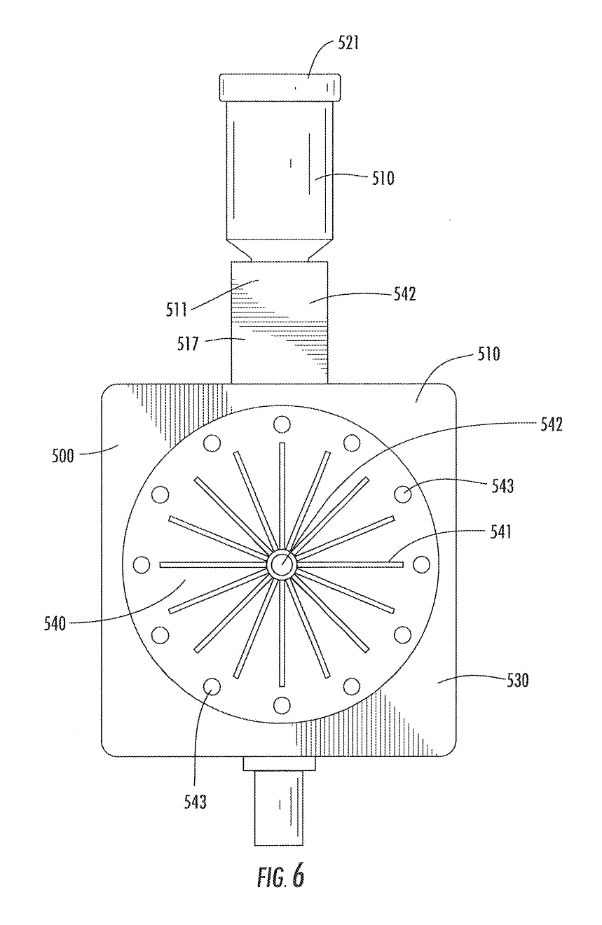

As shown in FIG. 6, the dispenser 500 further includes a spindle brush 540 powered by a rotation motor 530 positioned within the central housing 510. As illustrated, the spindle brush 540 includes a circular set of bristles 541 capable of rotating about a central axis 542. Positioned outside of the circular set of bristles 541 is a plurality of jet sprays 543. These various jet sprays 543 administer the cleanser 510 (and pressurized water 212) both directly on the user, as well as within the bristles 541. The cleanser 510 is supplied from the fluid container 520 shown in FIG. 6 via a tube 542 contained within the central housing 510. Likewise, pressurized water 212 is delivered via the multi pivot arm 400 (illustrated in FIGS. 1-3).

### Vertical Assembly

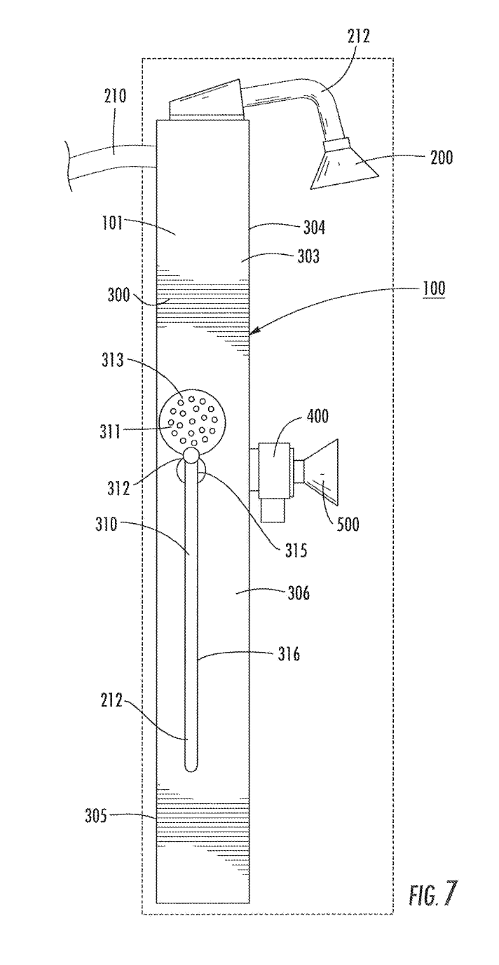

FIGS. 7 through 9 illustrate, by way of example, the primary components 101 of the vertical assembly 300. First turning to FIG. 7, the exterior shell 303 of the vertical assembly 300 is essentially rectangular in dimension and includes a front side 304, corresponding back side 305 and left side wall 306. The back side 305 of the exterior shell 303 is capable of being affixed and/or attached to an existing shower enclosure (either via a fastener or through an adhesive material such as a glue, resin or epoxy).

The left side wall 306 shown in FIG. 7 further illustrates how the vertical assembly 300 allows for the attachment of the pivoting top showerhead 200, the multi pivot arm 300 and other devices. Such devices can include, but are not necessarily limited to, an optional shower wand 310 having a plurality of jet sprays 311. The shower wand 310 provides a third source of directed pressurized water 212 to assist in manually cleaning a user. In addition to the jet sprays 311, the shower wand 310 includes a selector 312, positioned proximate to the wand head 313, which offers a variety of spray options, including various water message options. The shower wand 310 rests on a holder 315 positioned on the left side wall 306 of the vertical assembly 300. A conduit 316 connected to the water intake 210 provides pressurized water 212 to the shower wand 310.

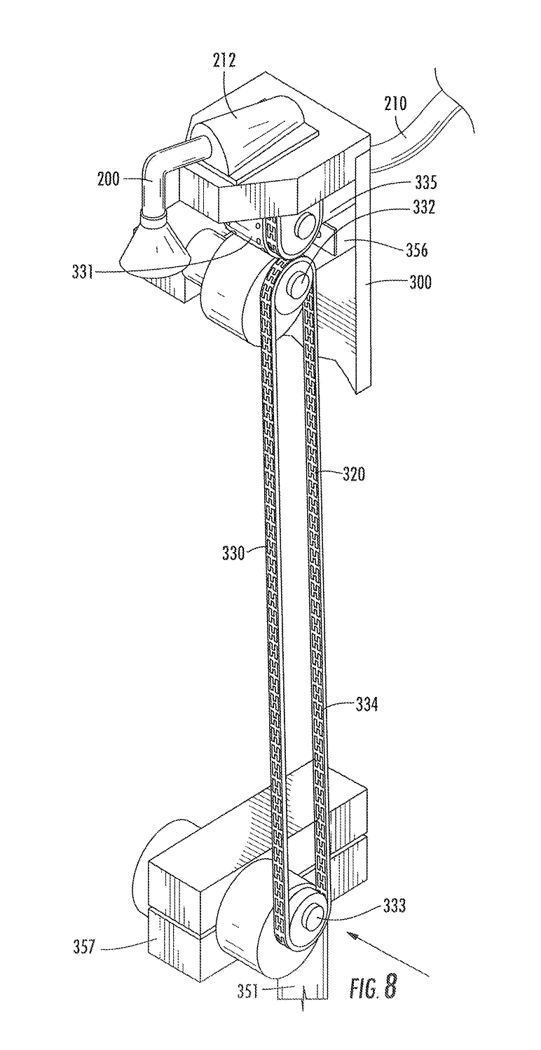

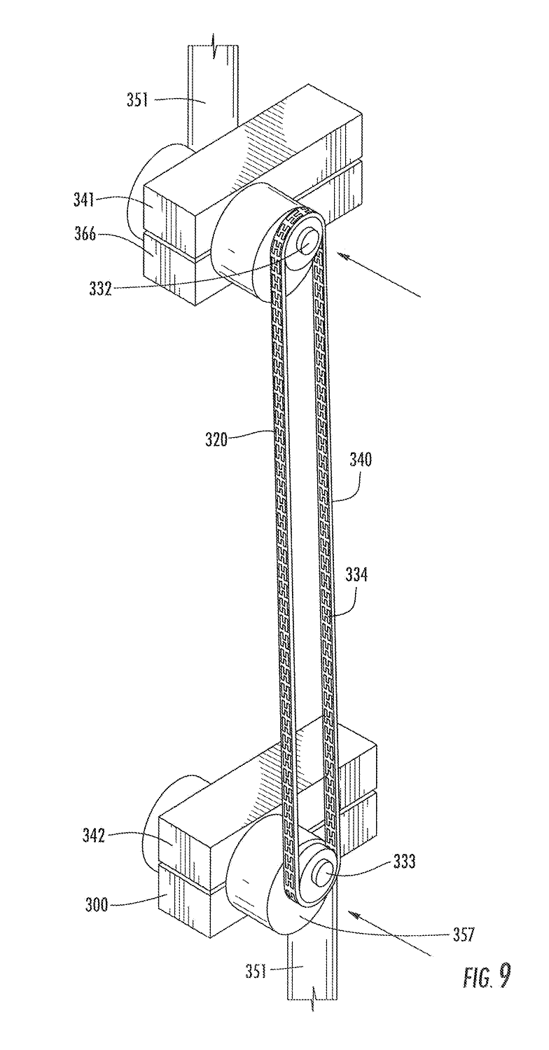

Both FIG. 8 and FIG. 9 illustrate various power trains 320 contemplated for use with the vertical assembly 300. The invention contemplates various power trains 320 which employ electrical, mechanical and hydraulic power (or combination thereof) to vertically move and position the multi pivot arm 400 about the vertical assembly 300. FIG. 8 illustrates a combination of a hydraulic and mechanical power train 320. In contrast, FIG. 9 illustrates a combination of an electrical and mechanical power train 320.

Now turning to FIG. 8, the first power train 320 is a hydraulic assembly 330 having a paddle drive 331, an upper threaded gear 332, a corresponding bottom threaded gear 333 (not shown) and rotating chain 334 (connected to both threaded gears 332 and 333). Preferably made of PVC or similar polymer material, the paddle drive 331 is in direct communication with the water intake 210. Such paddle drive 331 can also be used to help rotate the pivoting top showerhead 200 about the vertical assembly 300 to provide a larger cascade of pressurized water 212 about the user.

Through the flow of pressurized water 212 offered by the water intake 210, the paddle drive 331 rotates to power the upper threaded gear 332. A directional feed 335 positions pressurized water 212 either above or below the paddle drive 331, which in turn helps determine which way the paddle drive 331 rotates. For example, when pressurized water 212 flows above the paddle drive 331, the rotating chain 334 rotates downward. Conversely, placement of pressurized water 212 below the paddle drive 331 drives the rotating chain 334 upward.

Although FIG. 8 illustrates a hydraulic assembly 330, FIG. 9 offers an optional electric mechanical power drive 320 to elevate the multi pivot arm 400 about the vertical assembly 300. As shown, the motorized assembly 340 includes a first motor 341, an upper threaded gear 332, a corresponding bottom threaded gear 333 and rotating chain 334 (connected to both threaded gears 332 and 333). Similar to the hydraulic assembly 330, the first motor 341 powers the rotating chain 334 which rests on both threaded gears (332 and 333). The multi-pivot arm 400 engages the rotating chain 334 to elevate about specific positions on the vertical assembly 300.

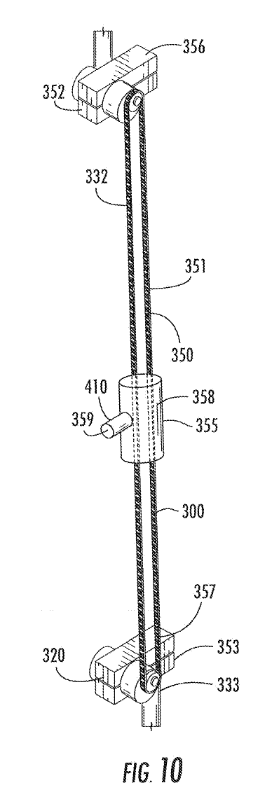

While FIG. 8 and FIG. 9 illustrate two optional power trains 320, FIG. 10 offers the internal structural components 350 for the vertical assembly 300. These primary structural components 350 include, but are not necessarily limited to, a stabilizing rod 351, a tubular guide 355, a top positioning brace 356 and a corresponding lower positioning brace 357. Roughly parallel to the exterior shell 303 of the vertical assembly 300, the stabilizing rod 351 functions to hold, maintain and position the power train 320 to properly elevate and position the multi pivot arm 400.

As further shown in FIG. 10, the stabilizing bar 351 includes a top end 352, a corresponding bottom end 353 and a middle portion 354. Affixed proximate the top end 352 is the top positioning brace 356. The upper threaded gear 332 of the power train 320 is positioned on the top positioning brace 356. Likewise, the lower threaded gear 333 helps maintain the bottom positioning brace 357. Accordingly, both positioning braces 356 and 357 help hold and maintain the various gears in place to hold the rotating chain 334.

FIG. 10 also shows use of a tubular guide 355 positioned along the stabilizing bar 351. The tubular guide 355 preferably includes an annular sleeve 358 and a perpendicular engaging bar 359. The annular sleeve 358 is a tubular like structure which surrounds the shaft of the stabilizing bar 351. Moreover, the annular sleeve 358 is sufficiently long so as to afford a stable platform in which to perpendicularly attach various components 101 of the shower attachment 100.

To accomplish this, a rigid engaging bar 359 attaches to the middle portion of the annular sleeve 358 which connects to the first arm 410 of the multi pivot arm 400. As previously discussed, the first arm 410 preferably connects to the rigid engaging bar 359 of the annular sleeve 358 via a first hinge 425.

As shown in FIG. 2, the shell 303 of the vertical assembly 300 preferably includes an elongated slit 307. Preferably, the elongated slit 307 is vertical in orientation and rectangular in shape. Moreover, the elongated slit 307 is of a sufficient size and dimension so as to allow the rigid engaging bar 359 of the annular sleeve 358 to exit the shell 303 to attach and rigidly maintain the multi pivot arm 400.

### The Multi Pivot Arm

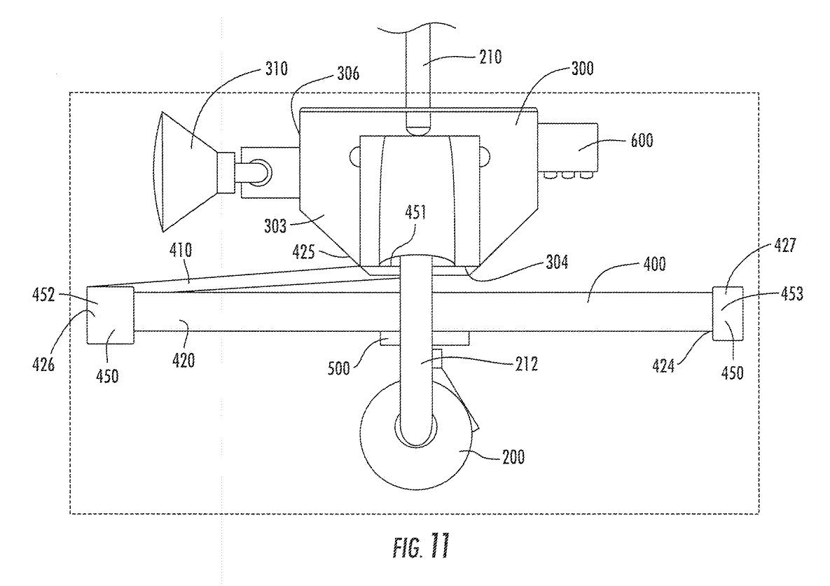

Both FIG. 11 and FIG. 3 provide additional views of the various components 101 and functionality of the multi pivot arm 400. FIG. 11 illustrates placement of the multi pivot arm 400 in light of the pivoting top showerhead 200, the vertical assembly 300, the shower wand 310, and the controller 600. Positioned at the front side 304 of the vertical assembly 300, the multi-pivot arm 400 is positioned below the pivoting top showerhead 200 and is capable of vertically moving about the shower enclosure. Moreover, the multi-pivot arm 400 should be placed in a manner so as not to interfere with either the controller 500 (positioned on the right side of the shell 303) or the shower wand 310 (positioned on the left side wall 306 of the shell 303).

As further illustrated in FIG. 3, multi pivot arm 400 includes a first arm 410 and corresponding second arm 420. Preferably, the first arm 410 has a length which mirrors the second arm 420. However, either arm 410 or 420 can vary in shape, size and orientation. It should be noted that both arms 410 and 420 can be custom configured to conform to the length and dimensions of the existing shower enclosure. Put another way, the multi pivot arm 400 should be scaled to properly fit both the user, as well as the shower enclosure. Likewise, the vertical length of the vertical assembly 300 should be scaled so as to fit the same shower enclosure and so as not to impede the bath tub, the tub filler and/or the various valves.

As further shown in FIG. 3, the multi pivot arm 400 is powered by a plurality of small motors 450. Each small motor 450 can be a small electrically powered motor, or alternatively could be powered through hydraulically via flow of pressurized water 212 provided by the water intake 210. As previously discussed, the first arm 410 connects to the vertical assembly 400 via a first hinge 425. Positioned proximate the first hinge 425 is a first motor 451 (not shown). This first motor 451 helps rotate the first hinge 425 to position and move the first arm 410. Likewise, a second motor 452 is positioned proximate the second hinge 426 (which connects the first arm 410 to the second arm 420). Accordingly, the second motor 452 helps rotate the second hinge 426 to properly rotate and position the second arm 420 about the vertical assembly 300.

The invention further contemplates connecting the dispenser 500 to the second arm 420 of the multi pivot arm 400 via a third hinge 427. Optionally, a third motor 453 can be attached to the third hinge 427 to help position the dispenser 500 in relation to the user. Such third hinge 427 shall have a greater range of motion when the dispenser 500 is located and positioned at the second end 424 of the second arm 420. Accordingly, the third motor 453 is able to power the third hinge 427—when positioned at the second end 424—to rotate almost 360 degrees when necessary.

### The Controller

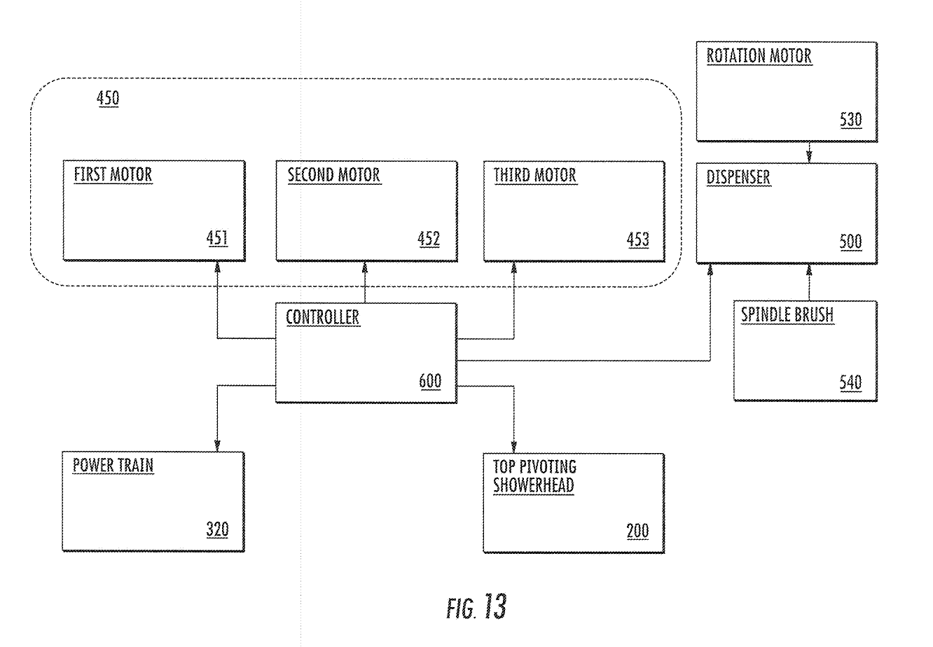

Both FIG. 12 and FIG. 13 illustrate the components 101 of the controller 600. As shown in FIG. 12, the controller 600 preferably includes a processor 610, a memory device 620, a power supply 630 (which can be a battery), and a display 640. Here, the memory device 620 contains a plurality of various programs which constitute routines in which the various components 101 of the shower attachment 100 can perform. For example, these programs can control movement of the various motors 450 (discussed above and in FIG. 11).

Both the processor 610 and display 640 communicate with (are supplied electricity by) the power supply 630. Such display 640 can provide a variety of information including the temperature of the pressurized water 212 (shown in FIG. 2), the time, as well as the various routines and subroutines stored and available on the memory device 620 (for execution by the processor 610). The display 640 can include a plurality of programming buttons 650 to enter which subroutine (shower program) to perform. Alternatively, the display 640 can be touch activated.

FIG. 13 illustrates how the controller 600 communicates with the various components 101 of the shower attachment 100. As shown, the controller 600 communicates with each of the various motors 450 which control the multi pivot arm 400 (shown in FIG. 3). Accordingly, the controller 600 commands the first motor 451, second motor 452 and third motor 453 to pivot and position the multi pivot arm 400 about the user, based upon specific routines stored as programs within the memory device 620 (shown in FIG. 12).

As is further shown in FIG. 13, the controller 600 communicates with the dispenser 500, which in turn directs the rotation motor 530 to power the spindle brush 540 as well as to administer the cleanser 510 (not shown) about the user. In addition, such controller 600 can instruct the power train 320 (whether it is mechanical, electrical or hydraulic) to elevate (lower or raise) the multi pivot arm 400 through positioning the annular sleeve 358 about the stabilizing bar 351 (both illustrated in FIG. 10).

That which is claimed:

1. A shower attachment comprising:
a vertical assembly having a top end, a corresponding bottom end and a stabilizing bar encased by an outer shell, wherein the outer shell includes a slit sufficient to gain access to the stabilizing bar;
a showerhead located at the top of the vertical assembly, the showerhead capable of receiving pressurized water through a water intake;
a pivot arm attached to the vertical assembly which includes a dispenser, the dispenser having a quantity of cleanser; and
a controller in communication with the pivot arm and dispenser.

2. The shower attachment of claim 1, further comprising:
a power train positioned within the outer shell of the vertical assembly;
an upper threaded gear which connects to the stabilizing bar through a top positioning brace;
a lower threaded gear which connects to the stabilizing bar through a bottom positioning brace;
a rotating chain attached to the upper threaded gear and lower threaded gear, wherein the rotating chain is in communication with the power train.

3. The shower attachment of claim 2, wherein the power train includes a paddle drive capable of powering the rotating chain and a directional feed which positions pressurized water either above or below the paddle drive.

4. The shower attachment of claim 1, wherein the pivot arm includes a first arm and a corresponding second arm having a first end and corresponding second end, the second arm further including a first track and corresponding second track in parallel relation to one another.

5. The shower attachment of claim 4, wherein the first arm to the stabilizing bar through a first hinge while the first end of the second arm attaches to the first arm through a second hinge.

6. The shower attachment of claim 5, wherein the first arm attaches to the stabilizing bar via an annular sleeve having a perpendicular engaging bar.

7. The shower attachment of claim 5, wherein a first motor is attached to the first hinge sufficient to position the first arm about the stabilizing bar.

8. The shower attachment of claim 5, wherein a second motor is attached to the second hinge sufficient to position the second arm about the first arm.

9. The shower attachment of claim 1, further comprising a shower wand detachable from the vertical assembly via a holder, the shower wand having a plurality of jet sprays and a selector.

10. The shower attachment of claim 1, wherein the controller includes a processor, a memory device in communication with the processor, a power supply to provide electricity to both the memory device and power supply and a display.

11. A shower attachment comprising:
a vertical assembly having a top end, a corresponding bottom end and a stabilizing bar encased by an outer shell,
a pivot arm attached to the vertical assembly, the pivot arm having a first arm and corresponding second arm, wherein the second arm includes a dispenser having a quantity of cleanser; and
a controller in communication with the pivot arm and dispenser.

12. The shower attachment of claim 11, further comprising:
a power train positioned within the outer shell of the vertical assembly;
an upper threaded gear which connects to the stabilizing bar through a top positioning brace;
a lower threaded gear which connects to the stabilizing bar through a bottom positioning brace;
a rotating chain attached to the upper threaded gear and lower threaded gear, wherein the rotating chain is in communication with the power train.

13. The shower attachment of claim 12, wherein the power train includes a paddle drive capable of powering the rotating chain and a directional feed which positions pressurized water either above or below the paddle drive.

14. The shower attachment of claim 11, wherein the second arm further including a first track and corresponding second track in parallel relation to one another.

15. The shower attachment of claim 14, wherein the first arm to the stabilizing bar through a first hinge while the first end of the second arm attaches to the first arm through a second hinge.

16. The shower attachment of claim 15, wherein the first arm attaches to the stabilizing bar via an annular sleeve having a perpendicular engaging bar.

17. The shower attachment of claim 15, wherein a first motor is attached to the first hinge sufficient to position the first arm about the stabilizing bar.

18. The shower attachment of claim 15, wherein a second motor is attached to the second hinge sufficient to position the second arm about the first arm.

19. The shower attachment of claim 11, further comprising a shower wand detachable from the vertical assembly via a holder, the shower wand having a plurality of jet sprays and a selector.

20. The shower attachment of claim 11, wherein the controller includes a processor, a memory device in communication with the processor, a power supply to provide electricity to both the memory device and power supply and a display.
